(19) United States
(12) Patent Application Publication
(10) Pub. No.: US 2007/0143163 A1
(43) Pub. Date: Jun. 21, 2007

(54) Systems and methods for organizing and monitoring data collection

(75) Inventors: Klaus D. Weiss, Hassloch (DE); Janet D. Salmon, Dudenhofen (DE); Guido Tesch, Bonn (DE); Stefan-Claudius Mueller, Eggenstein-Leopoldshafen (DE); Dirk Braun, Dielheim (DE)

Correspondence Address: SAP / FINNEGAN, HENDERSON LLP, 901 NEW YORK AVENUE, NW, WASHINGTON, DC, 20001-4413, US

(73) Assignee: SAP AG

(21) Appl. No.: 11/639,234

(22) Filed: Dec. 15, 2006

Related U.S. Application Data
(60) Provisional application No. 60/750,779, filed on Dec. 16, 2005.

(51) Int. Cl. G06F 9/44

(52) U.S. Cl. 705/7

(57) ABSTRACT

Methods, systems, apparatus and computer readable media are provided for managing data collection. In one implementation, a data collection initiative is implemented. Tasks associated with the data collection initiative are provided to participants, and information is received from the participants in response to the tasks. A status of the data collection initiative is provided based on the received information.

### CROSS-REFERENCE TO RELATED APPLICATION

This application claims the benefit of priority from U.S. Provisional Patent Application No. 60/750,779, entitled “Systems and Methods for Organizing and Monitoring Data Collection,” filed Dec. 16, 2005, the disclosure of which is expressly incorporated herein by reference to its entirety.

### TECHNICAL FIELD

The present invention generally relates to the field of data processing and information management. More particularly, the invention relates to systems, methods, apparatus, and computer-readable media for organizing and monitoring data collection.

### BACKGROUND INFORMATION

Data collection is vital to many organizations. There are many situations where organizations need to gather data from multiple parties. For example, an organization may need to collect employee opinions for subsequent business analyses. An organization may also need to collect accrual postings from accountants in multiple subsidiaries immediately prior to a period close and/or forecast data from multiple parties immediately after the period close. In such situations, the ability to collect data quickly and efficiently is imperative.

In certain situations, data collection may involve complexities resulting from various standards and/or business requirements. For example, in a budgeting process, data collection may require checking data consistency, approving and/or rejecting data with appropriate comments, and ensuring that targets and deadlines are met. These requirements may further complicate the timing and efficiency aspects of collecting data.

Data collection is particularly relevant to planning and forecasting activities, such as budget planning. Often, planning and forecasting requires a collaborative dialog among planning coordinators, planners, and other stakeholders during which goals must be set and activities agreed. Problems arise in selecting the parties to submit plans and the managers to approve plans. Problems also arise in managing the planning process as a project with deliverables and deadlines as well as monitoring responses to the plan, sending out reminders, accepting, rejecting or commenting on plans and viewing the aggregate results of the plan. Organizations also struggle with outdated distribution lists for the planners and approvers.

Existing solutions for managing data collection are often based on OLAP (Online Analytical Processing), a multi-dimensional data analysis. By way of example, existing solutions may be based on OLAP structures where individual “slices” of the structures are assigned to individuals and data received by individuals is monitored by “slice”. Such solutions for managing data collection are deficient in several respects. For instance, existing solutions lack functionality to adequately cope with outdated distribution lists. Further, existing solutions do not adequately faciliate efficient monitoring of data entered by various parties. In addition, existing solutions typically monitor the status of data collection by “slice” and do not provide varying views of the data collection. Also, while some existing solutions can distribute data collection tasks by e-mail and monitor whether data has been entered for a particular data slice, these solutions do not actively trigger activities.

### SUMMARY

Systems, methods, apparatus, and computer-readable media consistent with embodiments of the present invention may obviate one or more of the above and/or other issues and drawbacks. Consistent with an aspect of the invention, data collection initiatives may be organized and monitored.

Consistent with the present invention, a method for tracking data collection may be provided. The method may comprise: implementing a data collection initiative in a communications portal; providing a task associated with the data collection initiative to at least one participant through the portal; receiving through the portal information from the at least one participant in response to the task; and providing through the portal a status of the data collection initiative based on the received information.

Consistent with the present invention, another method for tracking data collection may be provided. The method may comprise: identifying a data collection initiative; providing a portal through which information associated with the data collection initiative is requested and received; receiving through the portal information from at least one participant; determining a status of the data collection initiative based on the received information; and providing a plurality of views of the status of the data collection initiative.

Consistent with the present invention, a method of organizing planning may be provided. The method may comprise: allowing a coordinator to establish a planning initiative associated with a goal, the planning initiative including a plurality of planning tasks and identifying planning participants; allowing the coordinator to assign the plurality of planning tasks to the participants; receiving information from the participants in response to the plurality of tasks; determining a status of each of the plurality of planning tasks based on the received information; determining a status of the planning initiative based on the status of each of the plurality of planning tasks; and allowing the user to track the planning initiative including the status of each planning task.

Consistent with the present invention, a system for tracking data collection may be provided. The system may comprise: a data processing system coupled to a network, the data processing system including a memory that stores instructions and a processor that executes the instructions. The instructions may include: instructions for implementing a communications portal; instructions for implementing a data collection initiative in the communications portal; instructions for providing a task associated with the data collection initiative to at least one participant through the portal; instructions for receiving through the portal information from the at least one participant in response to the task; and instructions for providing through the portal a status of the data collection initiative based on the received information. The system may further comprise an access device, coupled to the network, that accesses the communications portal.

Consistent with the present invention, another system for tracking data collection may be provided. The system may comprise: means for implementing a data collection initiative; means for providing a task associated with the data collection initiative to at least one participant; means for receiving information from the at least one participant in response to the task; and means for providing a status of the data collection initiative based on the received information.

Consistent with the present invention, a computer-accessible communications portal for tracking data collection may be provided. The portal may comprise: a selection module for allowing a user to implement a data collection initiative; a task module that allows the user to provide a task associated with the data collection initiative to at least one participant; a receiving module that receives information from the at least one participant in response to the task; and a status module that provides a status of the data collection initiative based on the received information.

Consistent with the present invention, a computer-readable medium containing instructions for controlling a computer system to perform a method may be provided. The method may comprise: implementing a data collection initiative in a communications portal; providing a task associated with the data collection initiative to at least one participant through the portal; receiving through the portal information from the at least one participant in response to the task; and providing through the portal a status of the data collection initiative based on the received information.

The foregoing background and summary are not intended to be comprehensive, but instead serve to help artisans of ordinary skill understand implementations consistent with the present invention as set forth in the appended claims. In addition, the foregoing background and summary are not intended to provide any independent limitations on the claimed invention or equivalents thereof.

### BRIEF DESCRIPTION OF THE DRAWINGS

The accompanying drawings show features of implementations consistent with the present invention and, together with the corresponding written description, help explain principles associated with the invention. In the drawings:

FIG. 1 is an illustration of exemplary aspects of the present invention;

FIG. 2 illustrates a screen shot of an exemplary interface provided by a data collection portal consistent with the present invention;

FIG. 3 illustrates a flowchart of an exemplary method of managing data collection consistent with the present invention;

FIG. 4 illustrates a flowchart of an exemplary method of creating a data collection initiative consistent with the present invention;

FIGS. 5A-5E illustrate screen shots of exemplary interfaces provided by a data collection portal consistent with the present invention;

FIG. 6-11 illustrate screen shots of other exemplary interfaces provided by a data collection portal consistent with the present invention;

FIG. 12 illustrates an exemplary architecture consistent with the present invention;

FIG. 13 illustrates exemplary components of a data collection portal consistent with the present invention; and

FIG. 14 illustrates an exemplary data processing system consistent with the present invention.

### DETAILED DESCRIPTION

The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with the invention. Other implementations and embodiments may be used and structural and procedural changes may be made without departing from the scope of present invention.

Introduction and Overview

Consistent with embodiments of the present invention, a data collection initiative may be managed. As used herein, the term “data collection initiative” refers to any coordinated effort to obtain information. Non-limiting examples of data collection initiatives include customer satisfaction surveys, employee surveys, financial and accounting planning and forecasting, budget planning, internal auditing, etc.

In one example, a data collection initiative may be associated with a business entity. Business entities may include enterprises, organizations, corporations, partnerships, firms, service providers, manufacturers, suppliers, distributors, wholesalers, retailers, educational institutions, government agencies, and the like. A business entity may undertake a data collection initiative for various reasons, such as planning and forecasting, to analyze business processes, to manage and streamline supply chains or enterprise resources, to evaluate customer and/or employee satisfaction, to comply with regulations and business practices, to forecast financials, etc.

Managing a data collection initiative may involve various functions, such as creating and coordinating data collection initiatives, assigning tasks associated with the initiative, allowing users to input information in accordance with data collection initiatives, and allowing users to view the overall status of data collection initiatives as well as individual aspects of initiatives. Managing a data collection initiative may also involve providing various notifications to users associated with the data collection initiatives.

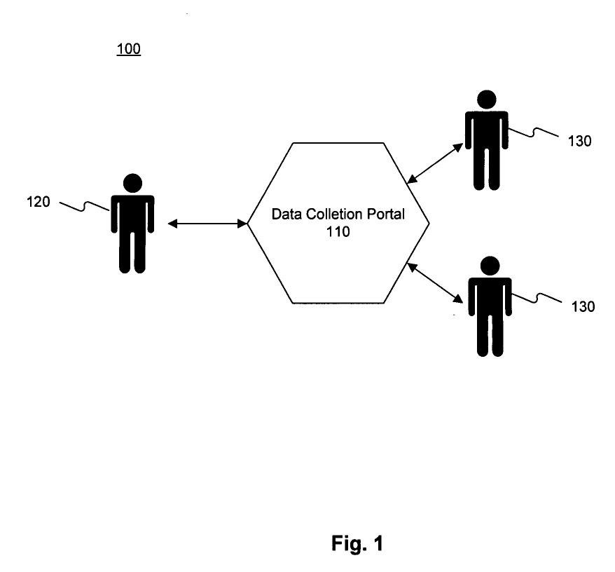

Consistent with certain embodiments of the present invention, a data collection initiative may be managed through a data collection portal. Accordingly, managing a data collection initiative may involve establishing a data collection portal. FIG. 1 illustrates an exemplary data collection portal 110, which may allow an initiative coordinator 120 to manage a data collection initiative.

Data collection portal 110 may serve as a gateway through which information relevant to a data collection initiative can be exchanged among various entities, such as the coordinator 120 and any number of participants 130. Data collection portal 110 may also monitor, track, store, and/or organize information and activities associated with a data collection initiative.

In certain implementations, data collection portal 110 may include a communications portal. In one example, data collection portal 110 may be implemented via one or more websites. Portal 110 may be configured as an intranet website, an extranet website, and/or an internet website. Data collection portal 110 may also be implemented as a user interface provided by one or more applications running on a server. Data collection portal 110 may be configured to exchange various forms of information, such as text, computer code, e-mail messages, database listings, recordings, audio signals, video signals, etc. Likewise, portal 110 may present information in various ways, such as visually (e.g., text, graphics, symbols, video, holographic images, etc.) and audibly (e.g., simulated speech, tones, recordings, etc.).

In one embodiment, data collection portal 110 may be implemented as a function or component of a business application. For example, portal 110 could be implemented as a component of an ERP (Enterprise Resource Planning) system, such as the mySAP™ ERP solution provided by SAP AG of Walldorf, Germany. Data collection portal 110 could alternatively be implemented within various other business-related applications and intelligence. In addition, the data collection portal may be integrated with an IT infrastructure and may interact with other applications, such as e-mail systems, storage components, and websites, to enable information exchange and provide tracking functions.

Consistent with certain embodiments of the present invention, initiative coordinator 120 and participants 130 may access information through portal 110. Initiative coordinator 120 may include any individual or entity responsible for implementing a data processing initiative. In one embodiment, coordinator 120 may include a management- or executive-level employee of a business entity. In an alternative embodiment, coordinator 120 could be a computer application, such as an artificial intelligence program, that is configured to implement a data collection initiative. Participants 130 may include individuals, such as managers, that provide information associated with their respective business units. Participants 130 may also include other employees, customers, planners, approvers, specialists, technicians, and/or executives. In an alternative embodiment, participants 130 may include automated systems or applications, such as business intelligence applications configured to obtain data from various sources.

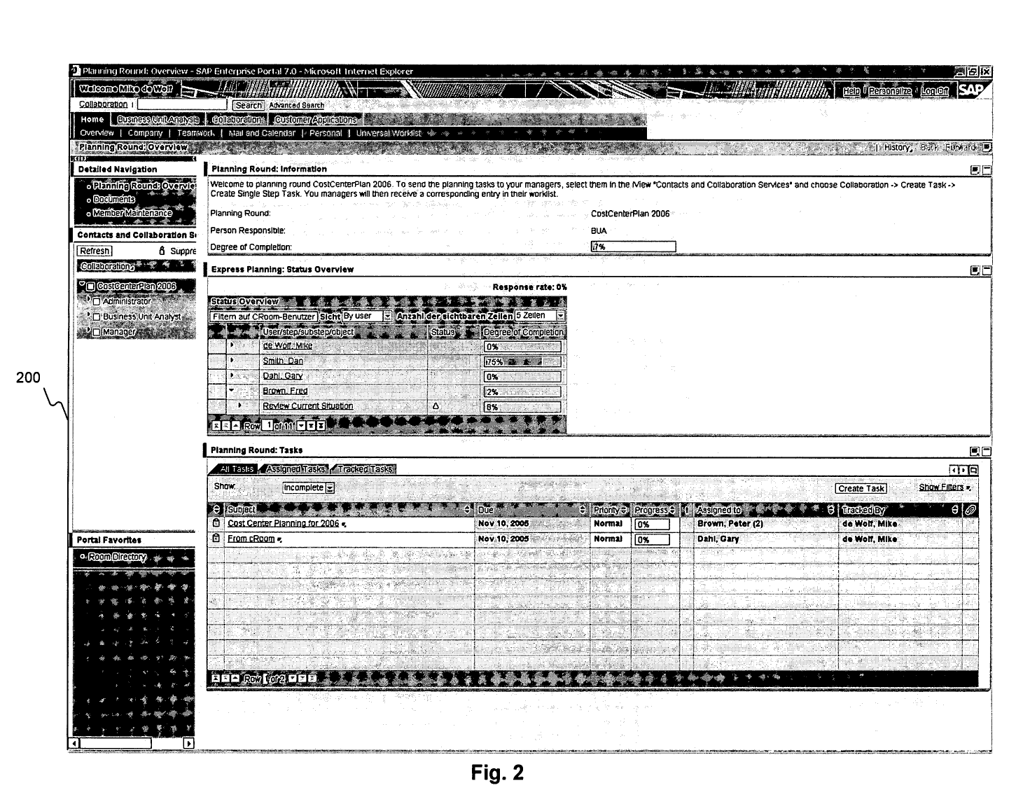

Data collection portal 110 may allow coordinator 120 to request information from participants 130. Portal 110 may also receive and store requested information, track the status of information requests, and provide access to the requests, information, and status. FIG. 2 illustrates an exemplary screen shot of an interface 200 that may be provided by portal 110 to allow a user to track the status of a data collection initiative. As shown in FIG. 2, a user may view the overall status (e.g., degree of completion) of the data collection initiative (or “planning round”) entitled “CostCenterPlan 2006.” In addition, the user may view the status of individual tasks, participants, and/or objects associated with the data collection initiative.

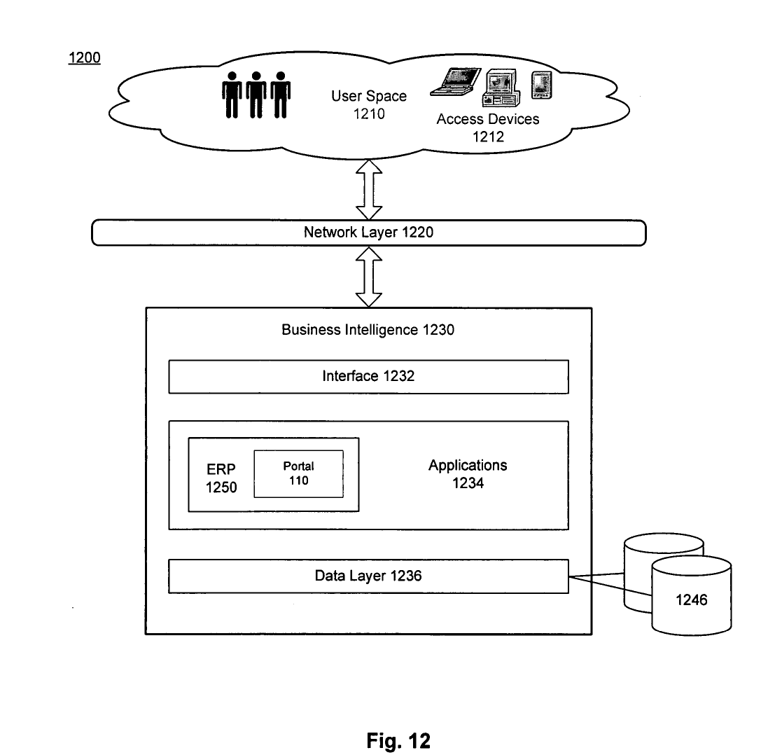

The number of coordinators and participants depicted in FIG. 1 is exemplary only, and a fewer or greater number of coordinators and participants may interact with portal 110. In addition, the coordinators and participants may be geographically dispersed and remotely access portal 110 via one or more networks (not shown). Details of an exemplary system architecture, including such a network, are presented below in connection with FIG. 12.

The foregoing overview is intended to introduce and provide initial clarity for some of the aspects associated with the present invention. Further details of the above-mentioned functionality and embodiments as well as additional aspects, features, and embodiments of the present invention will be described below.

Exemplary Method for Managing Data Collection

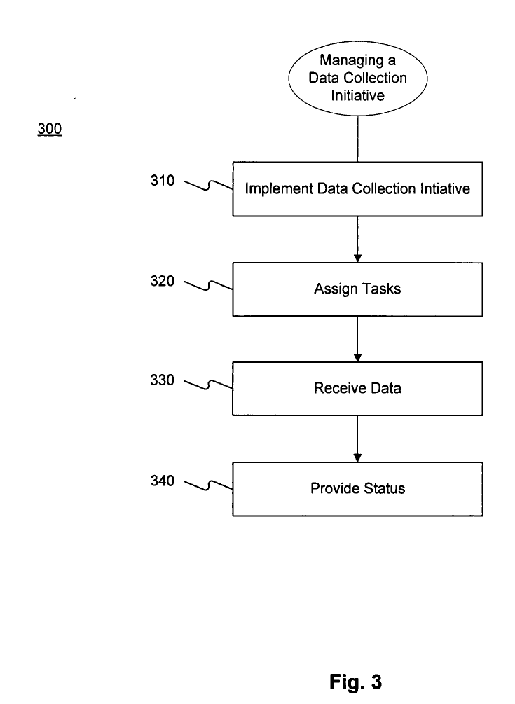

FIG. 3 illustrates a flowchart depicting an exemplary method 300 of managing data collection consistent with the present invention. As illustrated in the example of FIG. 3, managing data collection may comprise implementing a data collection initiative (stage 310), assigning tasks (stage 320), receiving data (stage 330), and providing a status of the data collection initiative (stage 340).

Implementing a Data Collection Initiative

Implementing a data collection initiative (stage 310) may include creating the initiative. Creating the initiative may involve identifying and specifying data for collection and appropriate data providers. Creating the data collection initiative may also involve identifying a coordinator (e.g., coordinator 120) for the initiative and participants (e.g., participants 130) that assist with the initiative (e.g., obtain information from data providers).

Consistent with certain embodiments of the present invention, a data collection initiative may be created using a data collection portal, such as portal 110. Coordinator 120 may create a data collection initiative by inputting information to an interface provided by portal 110. For example, portal 110 may present a series of user prompts and data fields for allowing users to input information. The portal could also present a series of menus and sub-menus from which a coordinator can select pre-loaded or dynamically-loaded items to create the initiative. As an example, portal 110 could dynamically load (in response to some user action) a list of managers in a particular business unit from one or more databases or applications. Portal 110 may present this list to coordinator 120 and allow coordinator 120 to select one or more managers (e.g., participants 130) to include in the data collection initiative.

Data collection portal 110 may also allow users to create new initiatives by selecting pre-loaded initiatives from one or more menus. For example, portal 110 may allow coordinator 120 to select a fully configured initiative from a menu or listing. These pre-loaded initiatives may be pre-configured and installed in portal 110, or they may be initiatives previously created and stored by coordinator 120 or other user.

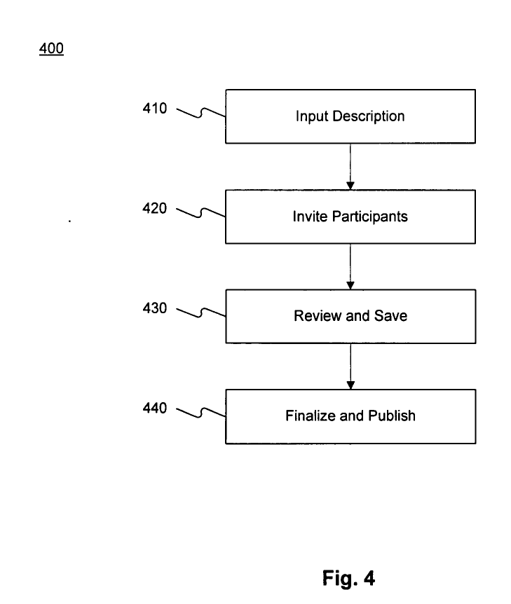

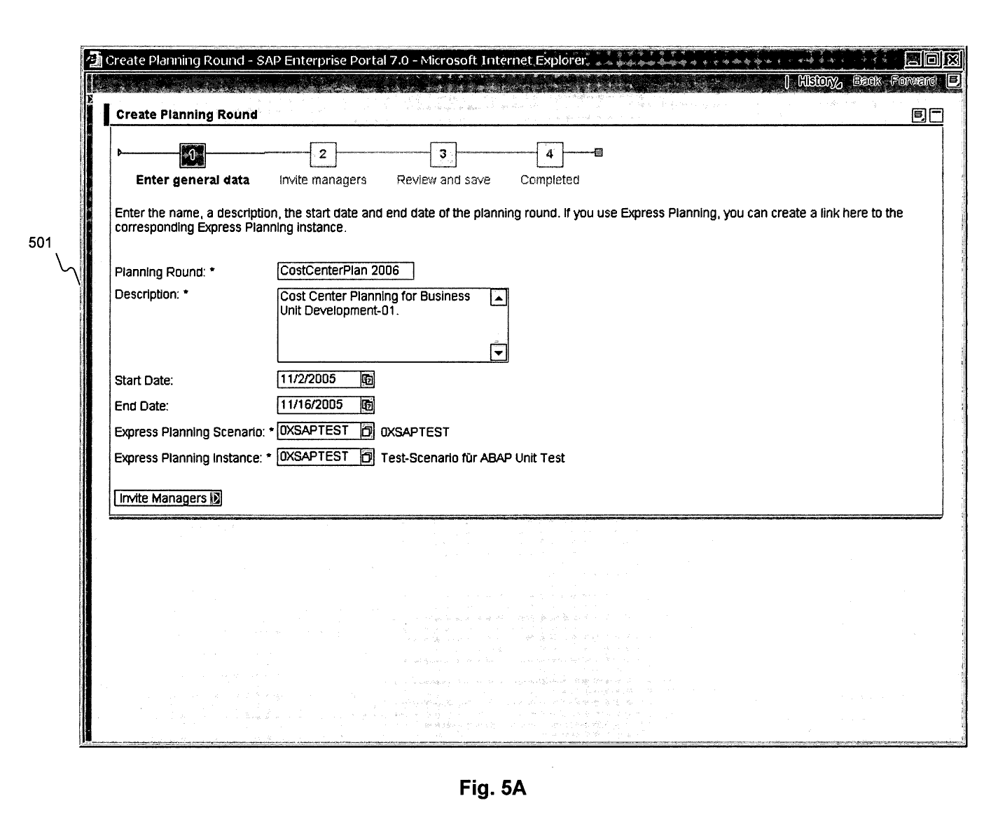

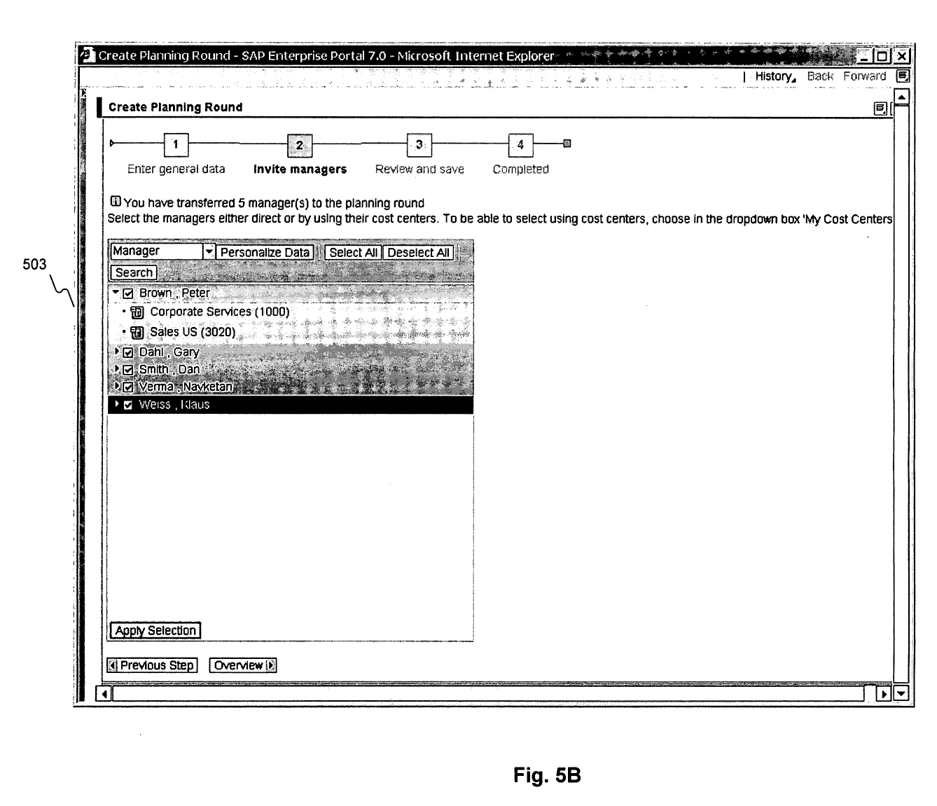

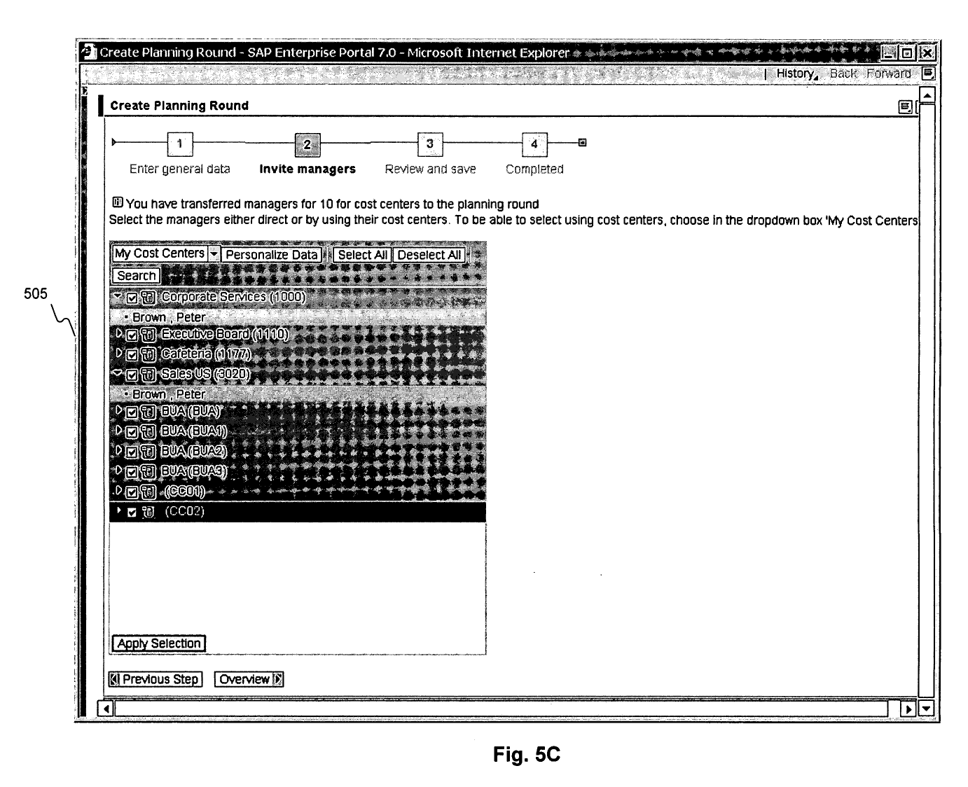

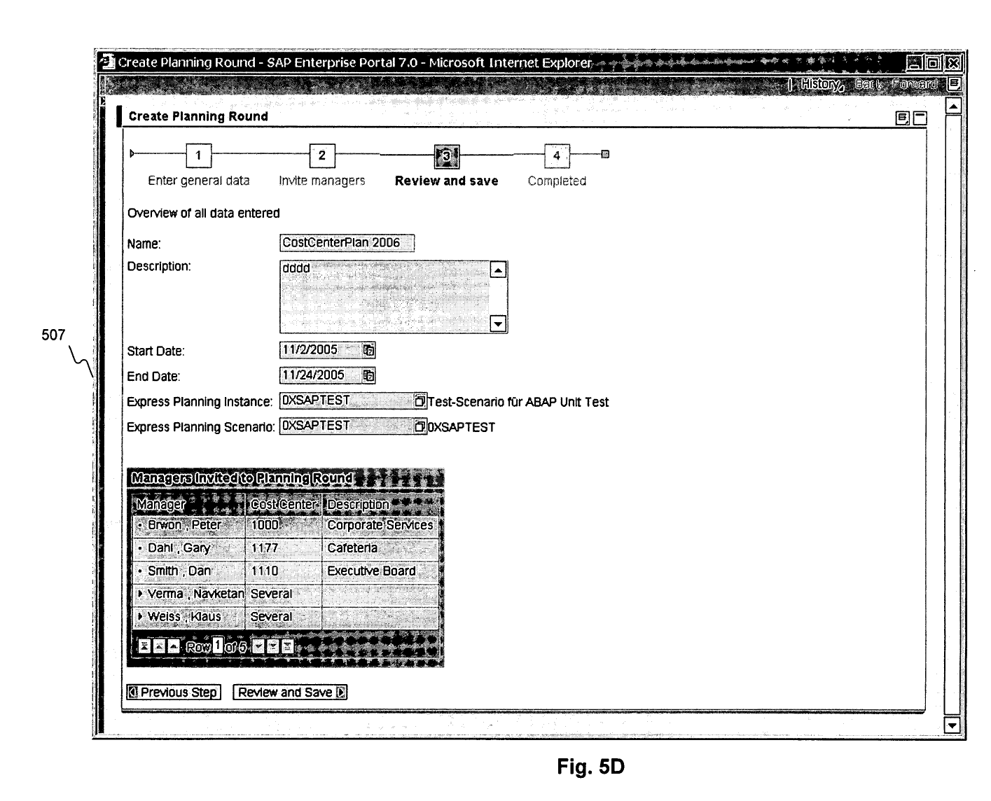

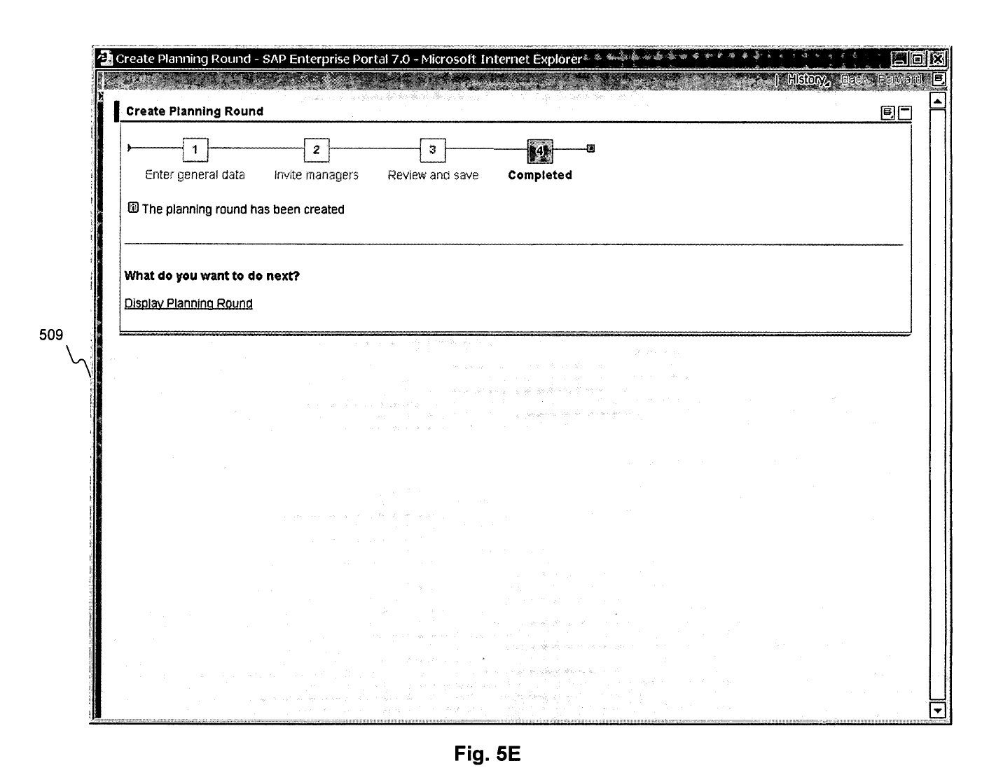

In one embodiment, the data collection portal may provide a “self-service” function for allowing coordinator 120 to create data collection initiatives. This functionality may present a coordinated series of steps that guide coordinator 120 through a pre-configured process for creating an initiative. FIG. 4 illustrates a flowchart of an exemplary self-service process 400 of creating a collection initiative consistent with the present invention. FIGS. 5A-5E illustrate exemplary portal screen shots corresponding to process 400.

As shown in FIG. 4, process 400 may begin when coordinator 120 specifies general data associated with the collection initiative (stage 410). This general data may include a name, a description, a start date, an end date, etc. As illustrated in screen shot 501 of FIG. 5A, coordinator 120 may specify this general data by either inputting the data in various data fields or by selecting pre-configured scenarios and instances, which may automatically populate certain data fields (e.g., “Express Planning” items in FIG. 5A).

After specifying general information, coordinator 120 may invite participants (stage 420), such as participants 130. As explained above, participants include any individual or entity that assist in the data collection initiative.

Coordinator 120 may manually search for and/or specify individuals or entities as participants. Alternatively, as illustrated in screen shot 503 of FIG. 5B, portal 110 could allow coordinator 120 to select from one or more dynamically-loaded lists of potential participants. For example, portal 110 may obtain listings (or other forms of information) of individuals or entities associated with the coordinator, such as organizational units, cost centers, projects, profit centers, business processes, etc. for which the coordinator is responsible. Portal 110 may also obtain information regarding objects for which these individuals or entities are responsible. Portal 110 may obtain the information regarding individuals and objects from various business intelligence applications (e.g., ERP systems) and/or databases. Portal 110 may load this information and allow coordinator 120 to search the information for participants. In one embodiment, portal 110 may also typify the individuals or entities associated with a given coordinator based on responsibilities, roles, expertise, etc. The portal may provide various view of potential participants and may allow the coordinator to search for participants based on various criteria. For example, as illustrated in screen shot 505 of FIG. 5C, portal 110 may allow coordinator 120 to view and search the managers of cost centers for which coordinator 120 is responsible.

In one embodiment, portal 110 may allow coordinator 120 to update the potential participant listings. For example, portal 110 may initially provide a listing of potential participants based on pre-stored information or information obtained from databases and/or applications. Portal 110 may allow coordinator 120 to view the listing and delete, edit, and add individuals or entities to the list. The portal may be configured to save the updated listing for future use.

After participants are invited, coordinator 120 may review and save (stage 430) the data collection initiative. In one embodiment, portal 110 may provide an overview of the data collection initiative to allow coordinator 120 to review the initiative. For example, as depicted in screen shot 507 of FIG. 5D, portal 110 may provide an overview of all data entered and selected by coordinator 120, including the invited participants 130. Portal 110 may allow coordinator 120 to edit any of the information entered and then save the initiative once edits are complete.

After review, the data collection initiative may be finalized and published (stage 440). As illustrated in screen shot 509 of FIG. 5E, portal 110 may also provide a confirmation that the initiative is created and provide a link to the initiative. In addition, portal 110 may allow coordinator 120 to publish the finalized initiative to all participants 130 of the initiative. Publishing the initiative may include allowing participants 130 to view and access the initiative via portal 110.

Assigning Tasks

Referring again to FIG. 3, after the data collection initiative is implemented (stage 310), tasks may be assigned to participants (stage 320). Coordinator 120 may create tasks and assign them to participants 130. As used herein, the term “task” refers to any action that coincides with a particular data collection initiative. A task may include providing information associated with the data collection initiative. For example, a task may include inputting financial information for specified period. A task may also include approving data, completing a form, submitting an e-mail, or updating a database. As another example, a task may include completing a survey. Non-limiting examples of specific tasks include headcount planning, statistical key figure planning, primary cost planning, and order planning.

In certain situations, a given task may include one or more task steps. The task steps may identify individual activities to be performed. Non-limiting examples of task steps include confirming current headcount, confirming current assets, acknowledging objectives, and documenting planned actions.

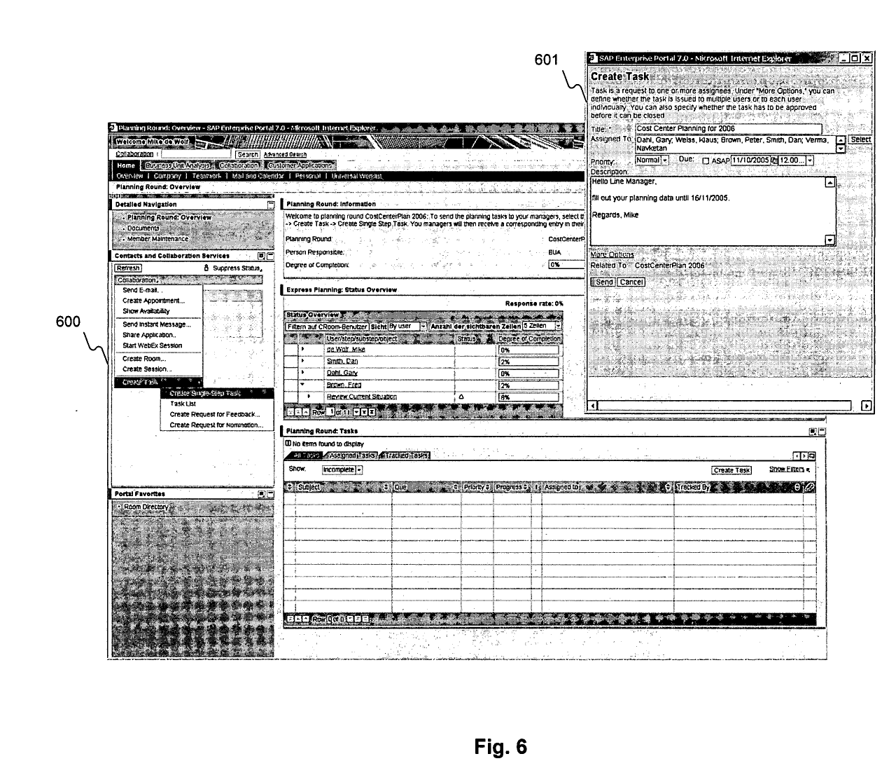

In one embodiment, assigning tasks may include creating tasks using data collection portal 110. Creating a task may involve naming the task, specifying a particular participant to perform the task, setting a priority for the task, establishing due dates for the task, and describing the task. FIG. 6 illustrates screen shots of exemplary interfaces 600 and 601 that may be provided by data collection portal 110 to assist coordinator 120 in creating a task. As illustrated in FIG. 6, coordinator 120 may select from a menu provided by portal 110 an option to create a task. In response to that selection, portal 110 may provide an interface 601 for creating the task. Interface 601 may prompt coordinator 120 to input or select a task title, a task description, a priority level, due dates, and assignments.

Assigning tasks may also include providing the created tasks to the responsible participants 130. Providing the created tasks may involve sending the task to one or more participants 130 via an electronic message. As illustrated in the example of FIG. 6, interface 601 may provide a selectable item for sending the created task to the responsible participants. In one embodiment, portal 110 may interact with various networks and messaging systems, and portal 110 may send electronic messages including the task to participants 130. Portal 110 could also publish the created task so that responsible participants 130 can view the task via portal 110. Portal 110 could send a notification of a task to the participants (e.g., via e-mail), and the participants, upon receiving the notification, could access portal 110 to view the published task.

In an alternative embodiment, portal 110 could provide access to the created task without sending the task or notifying participants 130. In that case, the created tasks may be provided to the responsible participants when the participants access the portal.

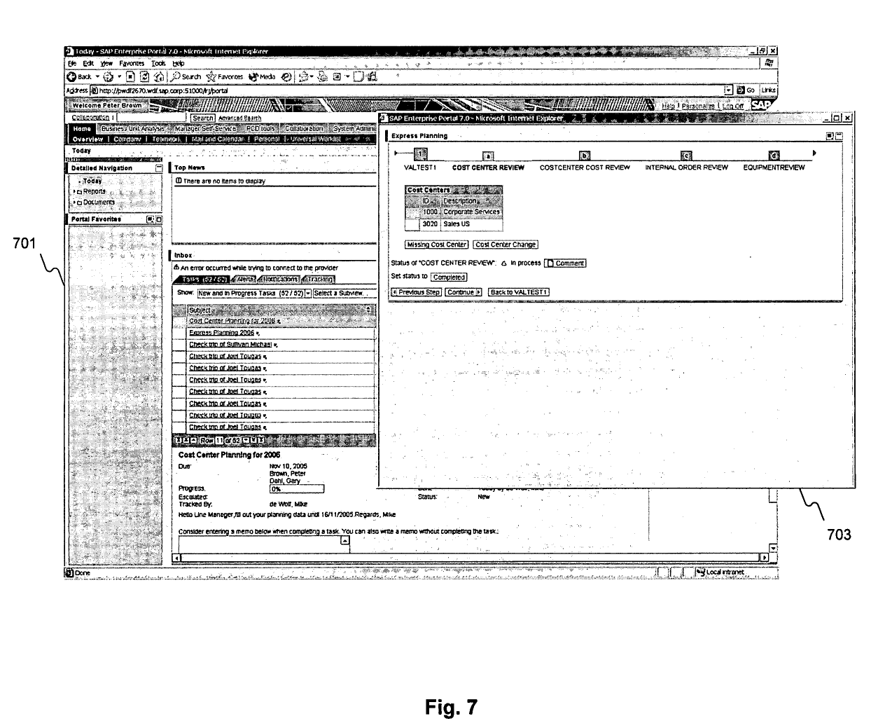

Consistent with certain embodiments of the present invention, assigning tasks to participants may include providing each participant with one or more task forms containing those objects or items (e.g., all production cost centers) for which the participant is responsible. The task forms may also contain one or more tasks (e.g., headcount planning, order planning, etc.) the participant is expected to perform and the related steps (e.g., confirm current headcount, document planned actions, etc.) of each task. These forms may be generated and provided to participants by portal 110. FIG. 7 illustrates an exemplary form 700 that portal 110 may provide to a given participant. Form 700 may be provided in a message to participant and may be accessed by the participant when the participant logs into portal 110 and views the message.

Receiving Data

Referring again to FIG. 3, managing a data collection initiative may include receiving data in response to assigned tasks (stage 330). For example, data may be received from participants 130 in response to the tasks created by coordinator 120. In one embodiment, receiving data in response to assigned tasks may include receiving the data via portal 110. Participants 130 may provide data in response to tasks in a variety of ways, such as via e-mail, websites, electronic forms, and other electronic submissions. Participants 130 may also provide data by inputting information to other systems, such as databases, that interact with portal 110.

Data collection portal 110 may be configured to receive data in response to tasks directly from participants 130. For example, portal 110 may allow participants to access one or more interfaces (e.g., a website) and input information to the interfaces. Portal 110 may provide participants with a link (e.g., via an e-mail), which routes participants 130 to such interfaces.

Data collection portal 110 may also be configured to receive data from participants 130 indirectly via one or more intermediate systems, such as applications and databases. For example, portal 110 may send participants links to websites or other applications hosted by intermediate systems (e.g., a remote network server) where information can be entered. The information may then be transferred to or obtained by portal 110. As another example, participants 130 may input information in response to tasks by updating a database and portal 110 may obtain the information from the database.

Receiving data in response to assigned tasks may additionally include storing the received data. The received data may be stored in order to track the status of data collection initiatives. In one example, after receiving information, portal 110 may store the information (e.g., using one or more databases) for tracking purposes. Portal 110 may be configured to store task forms and information received in response to task forms as instances of a particular data collection initiative.

Providing a Status of the Data Collection Initiative

Referring again to FIG. 3, managing a data collection initiative may include providing a status of the data collection initiative (stage 340). In one embodiment, providing a status of the data collection initiative may be performed by portal 110, which may include or leverage suitable functional logic. Providing a status of the data collection initiative may include determining the status of individual tasks, steps, participants, and data objects (e.g., forms, etc.), as well as determining the status of the initiative as a whole.

In one example, providing a status may include determining and providing standings of initiatives, tasks, sub tasks, or parts of sub tasks. These standings may be set manually or automatically, for example, per planning task, sub task, or sub task part. Non-limiting examples of standings include: Initial, In Progress, Sent, Being Checked, Rejected, In Revision Revised, and Approved.

Providing a status may also include determining and providing the progress of tasks, sub tasks, or parts of sub tasks, as well as the progress of initiatives as a whole. In one embodiment, determining progress may include calculating a degree of completion. The degree of completion may be expressed, in one example, as a percentage. Further, the degree of completion may be calculated in various ways.

In certain embodiments, the degree of completion may be calculated from the statuses (e.g., standings) of the different tasks. These statuses may be set manually or automatically per planning task, sub task, or even parts of sub tasks. Calculating the degree of completion of an initiative may involve aggregating the statuses of the tasks associated with the initiative. A formula may be used to aggregate the status information per data collection initiative (e.g., per planning round). As an example, the degree of completion may be calculated by the following formula:
[Number of Tasks in Status “Initial”×0%
+Number of Tasks in Status “In Progress”×0%
+Number of Tasks in Status “Sent”×50%
+Number of Tasks in Status “Being Checked”×50%
+Number of Tasks in Status “Rejected”×50%
+Number of Tasks in Status “In Revision”×50%
+Number of Tasks in Status “Revised”×50%
+Number of Tasks in Status “Approved”×100%]
/Total Number of Tasks

The foregoing example of aggregation is exemplary only, and other forms of aggregation are possible. Also, in certain embodiments, calculating a degree of completion may include comparing information received in response to the task, sub task, etc. with an expected amount of information. Participants may also specify a degree of completion, by for example inputting a degree to or selecting a degree from portal 110. Further, calculating a degree of completion may involve portal 110 obtaining the degree of completion from one or more business intelligence or other applications.

Additionally, if timeframes are defined for a particular data collection initiative (e.g., start date, end date, etc. associated with a planning round), the degree of elapsed time can evaluated. The ratio between the degree of completion and the elapsed time (e.g., as a percentage) may provide additional status information.

Once determined, the status of the data collection initiative (e.g., standings and progress) may be presented to or accessed by coordinator 120 and or participants 130 via portal 110. Presenting the status of the data collection initiative may include providing a user with a plurality of view of the status information. For example, the user may view the status by task, object, participant, etc. In addition, the user may view the status of individual tasks as well as the initiative as a whole. In one embodiment, presenting the status of the initiative may involve presenting an overview of the initiative. For example, portal 110 may list all assigned tasks and their statuses, the overall status of the initiative, as well as all participants and their responsibilities. Portal 110 may allow a user to switch between various views of this information and drill down to investigate further details of any particular item or status displayed. In addition, in each view the user can navigate to an entity, check the data for consistency, enter comments, and/or set a standing (e.g., approved, rejected, etc.) for the entity.

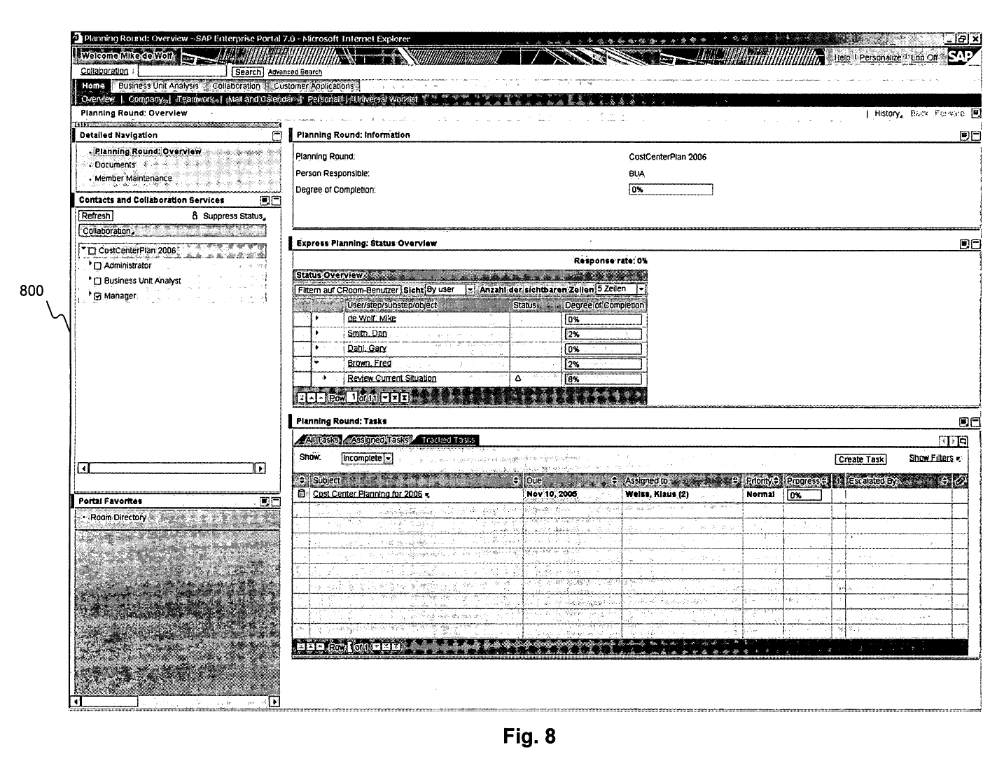

FIGS. 8-10 illustrate exemplary aspects of the invention for presenting the status of a data collection initiative. FIG. 8 illustrates an screen shot of an exemplary interface 800 that portal 110 may present to coordinator 120 to provide status information. As illustrated in FIG. 8, interface 800 may present the overall degree of completion of the initiative (i.e., CostCenterPlan 2006). Interface 800 may also present a “Status Overview” that displays the degree of completion of tasks for each participant, as well as the standing (i.e., the status column) for those tasks. Interface 800 may also display the progress of outstanding or incomplete tasks associated with the initiative (i.e., Cost Center Planning for 2006). As illustrated, the user can switch between various view of information. For example, the user can view all tasks, all assigned tasks, and all tracked tasks. Further, within those views the user can further specify viewing criteria. For example, the user can select to view all incomplete tracked tasks or all complete tracked tasks.

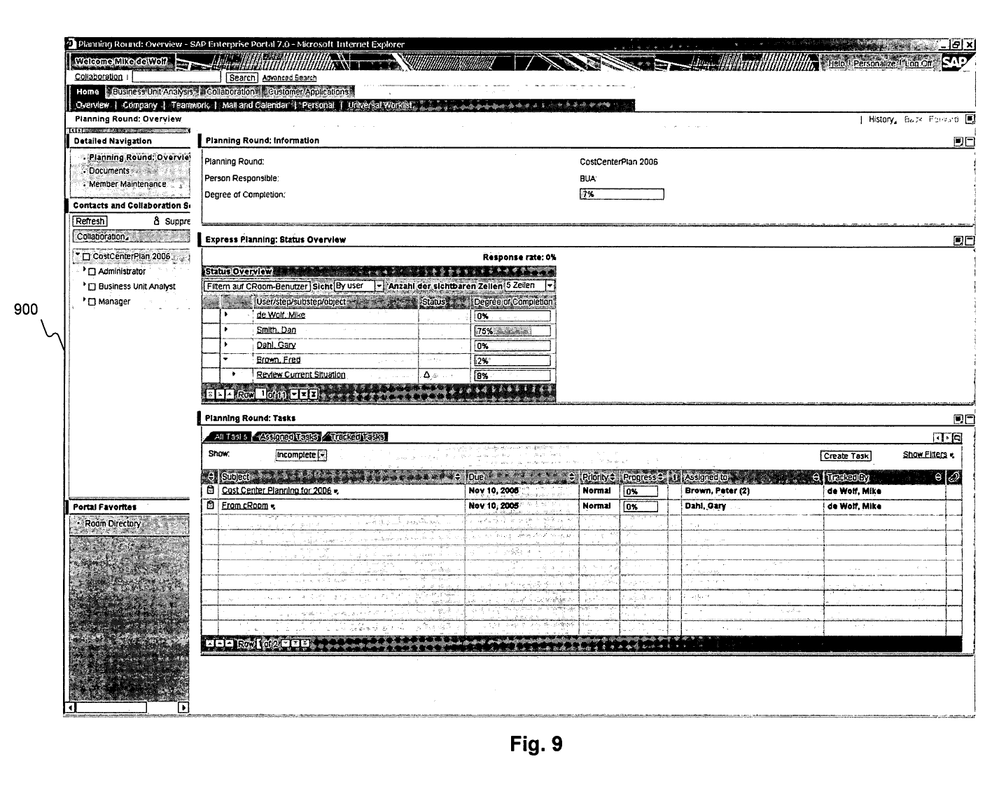

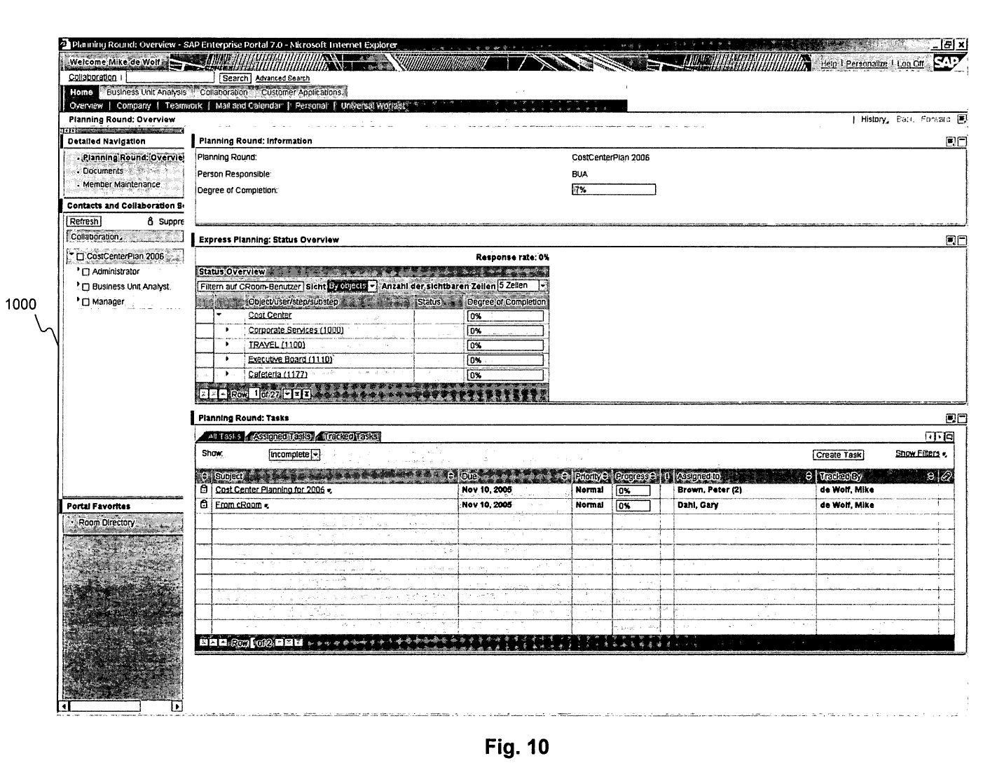

FIG. 9 illustrates another screen shot of an exemplary interface 900 that portal 110 may present to coordinator 120 to provide status information. As illustrated in FIG. 9, interface 900 may provide a “Status Overview” that presents the degree of completion by participant as well as the standing. Portal 110 may also provide status information by object. This is illustrated in FIG. 10, which depicts a screen shot of an exemplary interface 1000. As illustrated in FIG. 10, interface 1000 may provide a “Status Overview” that presents the degree of completion by object (e.g., cost center, corporate services, travel, executive board, cafeteria, etc.) as well as the standing (i.e., status column) of each object.

Consistent with certain embodiments of the present invention, presenting the status of a data collection initiative may additionally include providing “triggers” to coordinator 120. A trigger may include any indication or notification that some action should be taken. For example, a trigger may indicate to coordinator 120 that the status (e.g., standing or progress) of a particular item (e.g., a task) is ready for review and should be checked. A trigger may include a flag or other indication displayed on an interface provided by portal 110.

Triggers may be based on status information. In one embodiment, the status of tasks may be used to determine triggers. As an example, if there are 11 tasks in status “Sent,” coordinator 120 may be informed via a trigger that there are 11 tasks to be checked. The status profile and the respective triggers may be configurable and the coordinator may be informed if the number of tasks in a certain status was changed. The ratio between the degree of completion and the elapsed time of an initiative may also be used for generating and determining triggers. For example, this ratio may be used to generate and provide various automatic reminders to coordinator 120.

Triggers may be determined or generated when status information is determined and/or updated. Triggers may also be determined or generated at various pre-set time intervals. In one implementation, portal 110 may generate triggers. Other applications or systems interacting with portal 110 may also determine and/or generate triggers.

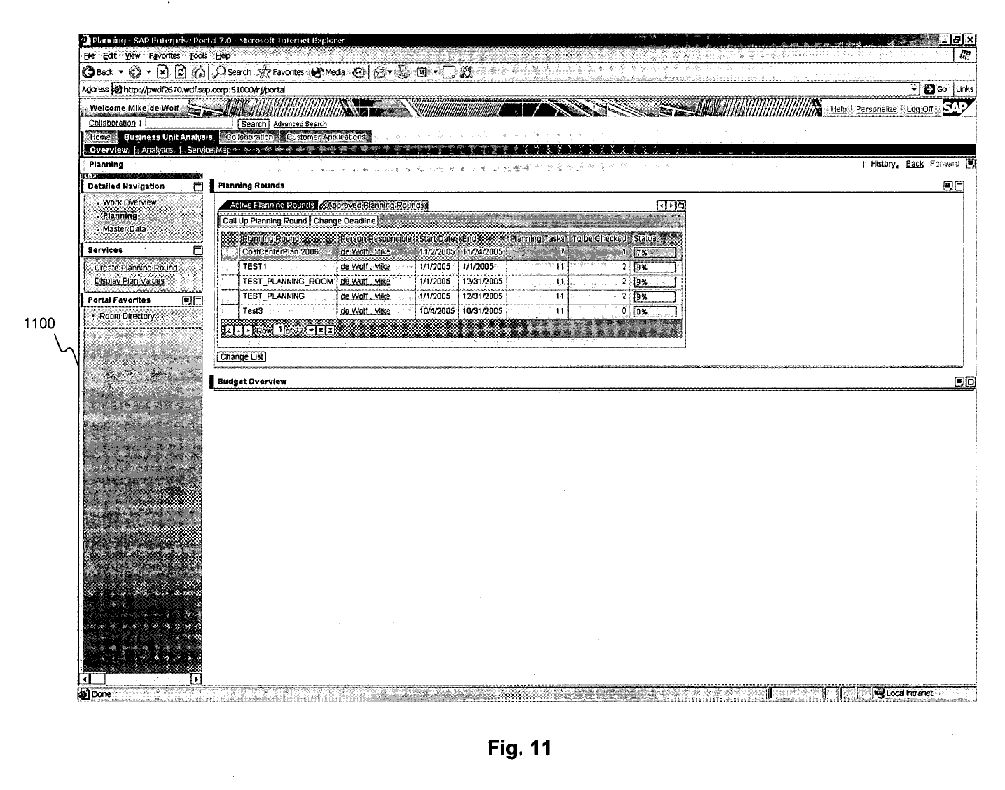

FIG. 11 illustrates a screen shot of an exemplary interface 1100 that displays triggers to coordinator 120. Interface 1100 may serve as central workspace or home page from which coordinator 120 can view all data collection initiatives associated with the coordinator. As illustrated in FIG. 11, interface 1100 may indicate for each initiative associated with coordinator 120 a number of items to be checked, as well as responsible parties, relevant dates, the number of tasks, and the overall status (e.g., degree of completion) of the initiative.

Exemplary Architecture

The illustrated methods and procedures may be implemented via one or more hardware, software, and/or firmware components. In one implementation, the functionality described above may be implemented in one or more software modules running on one or more data processing systems. In addition, various neural networks, decision trees, artificial intelligence engines, and/or other logic-based apparatus or processes may be employed for implementing functionality consistent with the present invention. The illustrated methods and procedures are not inherently related to any particular apparatus or system and may be implemented in conjunction with any suitable combination of components. One exemplary system architecture consistent with the present invention is detailed below in connection with FIG. 12.

FIG. 12 illustrates an exemplary architecture 1200 consistent with certain embodiments of the present invention. Architecture 1200 may include a user space 1210, a network layer 1220, and a business intelligence 1230. Architecture 1200 may, in at least one example, include elements to implement the methods described above.

User space 1210 may include one or more users, such as a coordinator 120 and participants 130, as well as one or more access devices 1212. Access devices 1212 may include any system, device, or apparatus suitable for allowing a user to access elements of architecture 1200 (such as network layer 1220) and send and receive information to/from those elements. Non-limiting examples of access devices 1212 include desktop computers, workstations, kiosks or “dumb” terminals, mobile computing devices (e.g., laptops, PDAs, a Blackberry™, an Ergo Audrey™, etc.), and mobile communications devices (e.g., cell phones). Any number of geographically-dispersed access devices, each similar or different in structure and capability, may be included in user space 1210.

User space 1210 may also include one or more networks (not shown) that may be used by access devices 1212. Such networks may be shared, public, or private data networks and encompass a wide area or local area. In one embodiment, user space 1210 may include a corporate intranet. User space 1210 may also be operatively coupled to the Internet. For example, access device 1212 may use the Internet to interact with user space 1210 and to interact with network layer 1220.

Network layer 1220 may be any appropriate structure for enabling communication between two or more nodes or locations. Network layer 1220 may include one or more shared, public, or private data networks and encompass a wide area or local area. Network layer 1220 may also include one or more broadband digital networks. Network layer 1220 may employ communication protocols such as User Datagram Protocol (UDP), Transmission Control and Internet Protocol (TCP/IP), Asynchronous Transfer Mode (ATM), SONET, Ethernet, or any other compilation of procedures for controlling communications among network locations. Further, in certain embodiments, network layer 1220 may leverage voice-over Internet Protocol (“VolP”) technology. Moreover, network layer 1220 may include optical fiber, Fibre Channel, SCSI, and/or iSCSI technology and devices.

Business intelligence 1230 may include one or more software, hardware, and/or firmware components and may leverage one or more logical components, processes, algorithms, systems, applications, and/or networks. For example, business intelligence 1230 may include one or more application servers configured to run various business applications. In one exemplary implementation, business intelligence 1230 may include an interface 1232, applications 1234, and a data layer 1236. In one embodiment, these components may be implemented within one or more application servers.

Interface 1232 may include hardware, software, and/or firmware components for allowing user space 1210 to interact with business intelligence 1230. In one example, interface 1232 may generate and/or provide one or more user interfaces.

Applications 1234 may include various intelligence components, such as an ERP application 1250, in which all or part of the functionality associated with portal 110 may be embedded. Applications 1234 may also include CRM (customer relationship management) systems, EAI (enterprise application integration) tools, CIM (Computer Integrated Manufacturing) tools, SCM (Supply Chain Management) systems, customer-, supplier-, and/or internal-oriented e-Business applications, and any other business-related application.

Data layer 1236 may manage data used by application 1234. Data layer 1236 may be embodied by various components, systems, networks, or programs and may include various hardware, software, and/or firmware components. In certain embodiments, data layer 1236 may provide one or more knowledge bases, which may be leveraged by applications 1234, including portal 110, to perform various functions. For example, portal 110 may use data layer 1236 to store and track information received in response to tasks and to calculate the degree of completion of various items.

Data layer 1236 may represent one or more structured data archives distributed among one or more network-based data processing systems. Data layer 1236 may be multidimensional in that it may organize data hierarchically and across several dimensions. In addition, data layer 1236 may be configured to provide data warehousing functions for a business entity. Data layer 1236 may include and/or leverage one or more schemas (e.g., file systems) for managing stored information. In certain configurations, data layer 1236 may leverage one or more elements from a storage area network (SAN). Data layer 1236 may include or be coupled to one or more databases 1246. Databases 1246 may include relational databases and systems (e.g., Oracle databases, DB2, MS SQL, etc.), distributed databases, object-oriented programming databases, and/or any other mechanism, device, or structure for managing, accessing, and updating an aggregation of data. Although depicted as separate from data layer 1236, data layer 1236 may include or encompass the functionality of databases 1246.

One or more of the components of business intelligence 1230 (e.g., applications 1234) may be embodied in one or more modules implemented in one or more programming languages, such as eXtendable Markup Language (XML), HTML, HTML with JavaScript, C/C++, Java, etc. These modules may be embedded on one or more memories and executed by one or more processors associated with business intelligence 1230.

The number and arrangement of components in architecture 1200 is not limited to what is shown in FIG. 12 and other variations in the number and arrangements of components are possible. For example, architecture 1200 may, depending on the implementation, lack certain illustrated components and/or contain, or be coupled to, additional or varying components not shown.

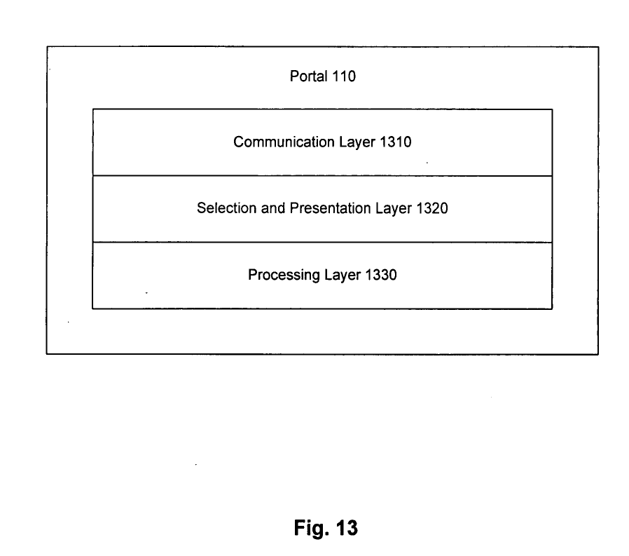

FIG. 13 illustrates exemplary components of portal 110 consistent with the present invention. As illustrated in FIG. 13, portal 110 may include a communication layer 1310, a selection and presentation layer 1320, and a processing layer 1330. The illustrated components are exemplary only, and other variations in the number, types, and arrangements of components are possible.

Portal 110 may be embodied in one or more modules implemented in one or more programming languages, such as eXtendable Markup Language (XML), HTML, HTML with JavaScript, C/C++, Java, etc. These modules may be embedded on one or more memories and executed by one or more processors associated with business intelligence 1230. For example, as explained above, portal 110 could be implemented as a component of an ERP system, such as the mySAP™ ERP solution provided by SAP AG. Alternatively, portal 110 may be a stand-alone application or device. In such alternative embodiments, portal 110 may include suitable hardware, software, and firmware for performing its various functions.

Communication layer 1310 may allow components of portal 110 to communicate with each other and with other elements, such as ERP system 1250 and data layer 1236. In one example, communication layer 1310 may include or provide various communication ports. Communication layer 1310 may also perform user authentication and access control. Communication layer 1310 may provide various user interfaces (which may generated by layer 1320) and allow coordinators (e.g., 120) and participants (e.g., 130) to access functionality associated with portal 110.

Selection and presentation layer 1320 may generate and provide user interfaces, electronic forms, reports, menus, GUI elements, etc. Selection and presentation layer 1320 may generate a gateway or front end through which one or more users can interact with functions of portal 110. Selection and presentation layer 1320 may include components for building various interface elements and structures. In one configuration, selection and presentation layer 1320 generate various interfaces, such as those illustrated in FIGS. 2, 5A-5E, and 11. Selection and presentation layer 1320 may also facilitate and process user selections and inputs to portal 110, as well as portal personalization options.

Processing layer 1330 may be configured to determine the status of data collection initiatives, including calculating degrees of completion. In addition, processing layer 1330 may provide various other features including, but not limited to, data access and searching, categorization, data profiling, and application integration. Processing layer 1330 may include various processing components and/or algorithms. For example, processing layer 1330 may include or perform one or more calculations or algorithms to determine the status of data collection initiatives. In one embodiment, processing layer 1330 may include various neural networks, decision trees, artificial intelligence engines, and/or other logic-based components.

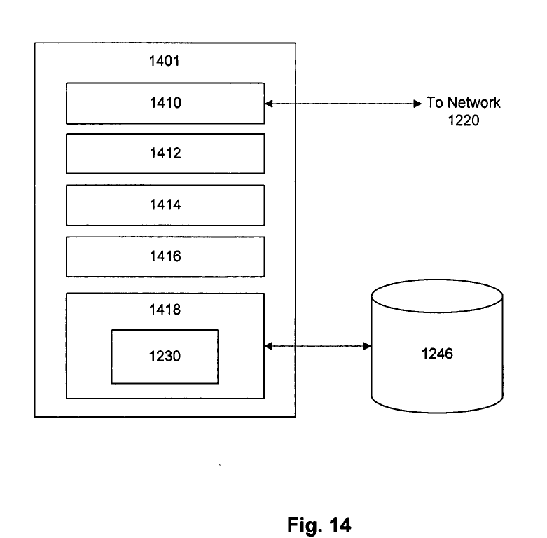

As explained above, portal 110 may be implemented within business intelligence 1230, which may include one or more data processing systems. FIG. 14 illustrates an exemplary data processing 1401 system consistent with the present invention.

Data processing system 1401 may represent any system, device, or apparatus suitable for processing information and implementing functionality consistent with the present invention. Data processing system 1401 may include a general-purpose computer, server, personal computer (e.g., a desktop), workstation, and other hardware-based processing systems known in the art. In certain implementations, data processing system 1401 may include mobile computing devices (e.g., laptops, PDAs, a Blackberry™, an Ergo Audrey™, etc.), mobile communications devices (e.g., cell phones), or other structures that enable users to remotely access information.

As shown in the example of FIG. 14, data processing system 1401 may include various components, such as a network interface 1410, a processor 1412, I/O devices 1414, a display 1416, and storage 1418. A system bus (not illustrated) may interconnect such components. The illustrated components are exemplary only, and data processing system 1510 may comprise additional components, fewer components, and/or varying components.

Network interface 1410 may be any appropriate mechanism and/or module for facilitating communication with a network, such as network 1220. Network interface 1410 may include one or more network cards and/or data and communication ports.

Processor 1412 may be configured for routing information among components and devices and for executing instructions from one or more memories. Although FIG. 14 illustrates a single processor, data processing system 1412 may include a plurality of general-purpose processors and/or special purpose processors (e.g., ASICS). In one example, data processing system 1412 may include a plurality of processors 1412 operating in parallel. Processor 1412 may be implemented, for example, using a Pentium™ processor commercially available from Intel Corporation.

I/O devices 1414 may include components such as keyboard, a mouse, a pointing device, and/or a touch screen. I/O devices 1414 may also include audio- or video-capture devices. In addition, I/O devices 1414 may include one or more data reading devices and/or input ports.

Data processing system 1401 may present information and interfaces (e.g., GUIs) via display 1416. Display 1416 may be configured to display text, images, or any other type of information. In certain configurations, display 1416 may present information by way of a cathode ray tube, liquid crystal, light-emitting diode, gas plasma, or other type of display mechanism. Display 1416 may additionally or alternatively be configured to audibly present information. Display 1416 may be used in conjunction with I/O devices 1414 for facilitating user interaction with data processing system 1401.

Storage 1418 may provide mass storage and/or cache memory for data processing system 1401. Storage 1418 may be implemented using a variety of suitable components or subsystems. Storage 1418 may include a random access memory, a read-only memory, magnetic and optical storage elements, organic storage elements, audio disks, and video disks. In certain configurations, storage 1418 may include or leverage one or more programmable, erasable and/or re-useable storage components, such as EPROM (erasable programmable read-only memory) and EEPROM (electrically erasable programmable read-only memory). Storage 1418 may also include or leverage constantly-powered nonvolatile memory operable to be erased and programmed in blocks, such as flash memory (i.e., flash RAM). Although a single storage module is shown, any number of modules may be included in data processing system 1418, and each may be configured for performing distinct functions.

Storage 1418 may include program code for various applications, an operating system, an application-programming interface, application routines, and/or other executable instructions. Storage 1418 may also include program code and information for communications (e.g., TCP/IP communications), kernel and device drivers, and configuration information. In one embodiment, instructions for implementing portal 110, or one or more components of business intelligence 1230, may be implemented in storage 1418. Further, storage 1418 may include or be coupled to one or more databases, such as databases 1246, as needed.

Referring back to FIG. 12, access devices 1212 may include components similar to those included in data processing system 1401, such as a network interface, a processor, I/O devices, a display, and storage. Access devices 1212 may, however, be structurally different from data processing system 1401 and may have varying or additional components. For example, access devices 1212 may be configured with less storage capacity and processing power than data processing system 1401 in order to reduce cost and size. In addition, access devices 1212 may include user interface components, such as displays, input devices, etc., while data processing system 1401 may lack such components.

FIGS. 1-14 are consistent with exemplary embodiments of the present invention. Further, the sequences of events described in connection with FIGS. 3 and 4 are exemplary and not intended to be limiting. Other steps may therefore be used, and even with the methods depicted in FIGS. 3 and 4, the particular order of events may vary without departing from the scope of the present invention. Further, the illustrated steps may overlap and/or may exist in fewer steps. Moreover, certain steps may not be present and additional steps may be implemented in the illustrated methods. The illustrated steps may also be modified without departing from the scope of the present invention and its embodiments.

For purposes of explanation only, certain aspects of the present invention are described herein with reference to the discrete functional blocks illustrated in FIGS. 12-14. The functionality of the illustrated blocks may, however, overlap and/or may be present in any number of elements and modules. Elements of each system may, depending on the implementation, lack certain illustrated components and/or contain, or be coupled to, additional or varying components not shown. Further, all or part of the functionality of the illustrated blocks may co-exist or be distributed among several geographically dispersed locations. Moreover, embodiments, features, aspects and principles of the present invention may be implemented in various environments and are not limited to the illustrated environments and architectures.

The foregoing description of possible implementations consistent with the present invention does not represent a comprehensive list of all such implementations or all variations of the implementations described. The description of only some implementations should not be construed as an intent to exclude other implementations. Artisans will understand how to implement the invention in the appended claims in many other ways, using equivalents and alternatives that do not depart from the scope of the following claims.

What is claimed is:

1. A method for tracking data collection, comprising:
implementing a data collection initiative in a communications portal;
providing a task associated with the data collection initiative to at least one participant through the portal;
receiving through the portal information from the at least one participant in response to the task; and
providing through the portal a status of the data collection initiative based on the received information, wherein the status includes at least a degree of completion.

2. The method of claim 1, wherein providing a status of the data collection initiative comprises providing through the portal a plurality of views of the status of the data collection initiative.

3. The method of claim 1, wherein providing a status of the data collection initiative comprises determining a status of the task based on the received information, the status of the task including at least a degree of completion.

4. The method of claim 3, wherein determining a status of the task comprises determining a percentage of completion of the task based on the received information.

5. The method of claim 4, wherein determining a percentage of completion comprises comparing the received information with an expected amount of information.

6. The method of claim 1, wherein providing a task comprises assigning the task to the at least one participant.

7. The method of claim 1, wherein providing a task comprises selecting from list of current potential participants the at least one participant.

8. The method of claim 1, further comprising obtaining the list of current potential participants from an enterprise resource management system.

9. The method of claim 1, wherein providing a task comprises providing an electronic form to the at least one participant and wherein receiving information comprises receiving the electronic form.

10. The method of claim 9, wherein providing the electronic form comprises providing a personalized electronic form to the at least one participant.

11. The method of claim 1, wherein providing a task comprises requesting the participant to input information through the portal.

12. The method of claim 1, further comprising:
providing through the portal a trigger, indicating an action to be completed, based on the determined status.

13. A method for tracking data collection, comprising:
identifying a data collection initiative;
providing a portal through which information associated with the data collection initiative is requested and received;
receiving through the portal information from at least one participant;
determining a status of the data collection initiative based on the received information, wherein the status includes at least a degree of completion; and
providing a plurality of views of the status of the data collection initiative.

14. A method of organizing planning, comprising:
allowing a coordinator to establish a planning initiative associated with a goal, the planning initiative including a plurality of planning tasks and identifying planning participants;
allowing the coordinator to assign the plurality of planning tasks to the participants;
receiving information from the participants in response to the plurality of tasks;
determining a status, including a degree of completion, of each of the plurality of planning tasks based on the received information;
determining a status, including an overall degree of completion, of the planning initiative based on the status of each of the plurality of planning tasks; and
allowing the user to track the planning initiative including the status of the planning initiative and the status of each planning task.

15. The method of claim 14, wherein allowing the user to track the planning initiative comprises allowing the user to view the status of each planning task according to the participants.

16. The method of claim 14, wherein allowing the user to track the planning initiative comprises allowing the user to view the status of each planning task according to the planning tasks.

17. The method of claim 14, further comprising identifying an object associated with the information and tracking a status of the object.

18. The method of claim 17, wherein allowing the user to track the planning initiative comprises allowing the user to view the status of the object.

19. The method of claim 17, wherein allowing the user to track the planning initiative comprising allowing the user to view the status of each planning task according to the objects.

20. The method of claim 14, wherein allowing the user to track the planning initiative comprises allowing the user to view the status of the each planning task according to objects associated with the received information.

21. A system for tracking data collection, comprising:
a data processing system coupled to a network, the data processing system including a memory that stores instructions and a processor that executes the instructions, the instructions including:
instructions for implementing a communications portal;
instructions for implementing a data collection initiative in the communications portal;
instructions for providing a task associated with the data collection initiative to at least one participant through the portal;
instructions for receiving through the portal information from the at least one participant in response to the task; and
instructions for providing through the portal a status, including a degree of completion, of the data collection initiative based on the received information; and
an access device, coupled to the network, that accesses the communications portal.

22. A system for tracking data collection, comprising:
means for implementing a data collection initiative;
means for providing a task associated with the data collection initiative to at least one participant;
means for receiving information from the at least one participant in response to the task; and
means for providing a status, including a degree of completion, of the data collection initiative based on the received information.

23. A computer-accessible communications portal for tracking data collection, comprising:
a selection module for allowing a user to implement a data collection initiative;
a task module that allows the user to provide a task associated with the data collection initiative to at least one participant;
a receiving module that receives information from the at least one participant in response to the task; and
a status module that provides a status, including a degree of completion, of the data collection initiative based on the received information.

24. A computer-readable medium containing instructions for controlling a computer system to perform a method, the computer system having a processor for executing the instructions, the method comprising:
implementing a data collection initiative in a communications portal;
providing a task associated with the data collection initiative to at least one participant through the portal;
receiving through the portal information from the at least one participant in response to the task; and
providing through the portal a status of the data collection initiative based on the received information, wherein the status includes at least a degree of completion.
